(19) United States
(12) Patent Application Publication
(10) Pub. No.: US 2025/0377975 A1
(43) Pub. Date: Dec. 11, 2025

(54) STORAGE DEVICE FOR CONTROLLING FLUSH AREA AND METHOD OF OPERATING THE SAME

(71) Applicant: SK hynix Inc., Gyeonggi-do (KR)

(72) Inventor: Eun Jae OCK, Gyeonggi-do (KR)

(21) Appl. No.: 18/969,257

(22) Filed: Dec. 5, 2024

(30) Foreign Application Priority Data
Jun. 5, 2024 (KR) 10-2024-0073629

(51) Int. Cl. G06F 11/10

(52) U.S. Cl. CPC G06F 11/1068; G06F 11/1004; G06F 11/1048

(57) ABSTRACT

Provided herein may be a storage device for controlling a flush area and a method of operating the same. The storage device may include: a buffer memory device including a flush area configured to temporarily store data provided from a host; a memory device configured to store the data output from the flush area; and a memory controller configured to adjust a size of the flush area based on a number of internal operations related to a possibility of losing the data stored in the flush area.

### CROSS-REFERENCE TO RELATED APPLICATION

The present application claims priority under 35 U.S.C. § 119 (a) to Korean patent application number 10-2024-0073629 filed on Jun. 5, 2024, the entire disclosure of which is incorporated by reference herein.

### BACKGROUND

### 1. Field of Invention

Various embodiments of the present disclosure generally relate to a semiconductor device, and more particularly to a storage device for controlling a flush area and a method of operating the storage device.

### 2. Description of Related Art

A storage device is a device which stores data under the control of a host device, for example, a mobile terminal such as a computer, a smartphone, or a tablet, or various types of electronic devices. The storage device may include a memory device which stores data, a buffer memory device which temporarily stores data, and a memory controller which controls the memory device and the buffer memory device.

The storage device may temporarily store data, received from the host device, in a flush area. Further, after the storage device collects the data in the flush area, the storage device may store the data, stored in the flush area, in the memory device in response to a request from the host device or depending on a specific condition. This operation may be referred to as a flush operation, whereby the performance of the storage device may be improved.

During the operation of the storage device, a sudden-power off (SPO) in which power supplied to the storage device is suddenly interrupted may occur. When a sudden-power off occurs before a flush operation is performed after the data is temporarily stored in the flush area, the data stored in the flush area may be lost. Therefore, there is a need to improve the reliability of the storage device by minimizing the possibility of losing the data stored in the flush area.

### SUMMARY

Various embodiments of the present disclosure are directed to a storage device capable of minimizing data loss by variably controlling the size of a flush area, thus improving reliability, and a method of operating the storage device.

An embodiment of the present disclosure may provide for a storage device. The storage device may include: a buffer memory device including a flush area configured to temporarily store data provided from a host; a memory device configured to store the data output from the flush area; and a memory controller configured to adjust a size of the flush area based on a number of internal operations related to a possibility of losing the data stored in the flush area.

An embodiment of the present disclosure may provide for a method of operating a storage device, the storage device including a flush area configured to temporarily store data provided from a host. The method may include: performing internal operations related to a possibility of losing data stored in the flush area; counting a number of the internal operations during a first period; counting a number of the internal operations during a second period subsequent to the first period; comparing the number of the internal operations counted during the first period with the number of the internal operations counted during the second period; and adjusting a size of the flush area based on a result of comparing the number of the internal operations counted during the first period with the number of the internal operations counted during the second period.

An embodiment of the present disclosure may provide for a memory controller for controlling a flush area configured to temporarily store data provided from a host. The memory controller may include: an internal operation information storage configured to store a number of internal operations related to a possibility of losing data stored in the flush area for each of a plurality of periods; and a flush area controller configured to adjust a size of the flush area based on the number of internal operations corresponding to each of a plurality of periods.

### BRIEF DESCRIPTION OF THE DRAWINGS

FIG. 1 is a diagram illustrating a storage device according to an embodiment of the present disclosure.

FIG. 2 is a diagram illustrating internal operation information related to the possibility of losing data stored in a flush area and an operation of adjusting the size of the flush area, according to an embodiment of the present disclosure.

FIGS. 3A to 3E are diagrams illustrating an operation of determining whether a trigger condition is satisfied, according to an embodiment of the present disclosure.

FIG. 4 is a diagram illustrating an operation of adjusting the size of a flush area, according to an embodiment of the present disclosure.

FIG. 5 is a flowchart illustrating a method of operating a storage device, according to an embodiment of the present disclosure.

FIG. 6 is a flowchart illustrating a method of operating a storage device, according to an embodiment of the present disclosure.

FIG. 7 is a diagram illustrating a memory controller according to an embodiment of the present disclosure.

### DETAILED DESCRIPTION

Specific structural or functional descriptions of the embodiments of the present disclosure introduced in this specification are provided as examples to describe embodiments according to the concept of the present disclosure. The embodiments according to the concept of the present disclosure may be practiced in various forms, and should not be construed as being limited to the embodiments described in the specification.

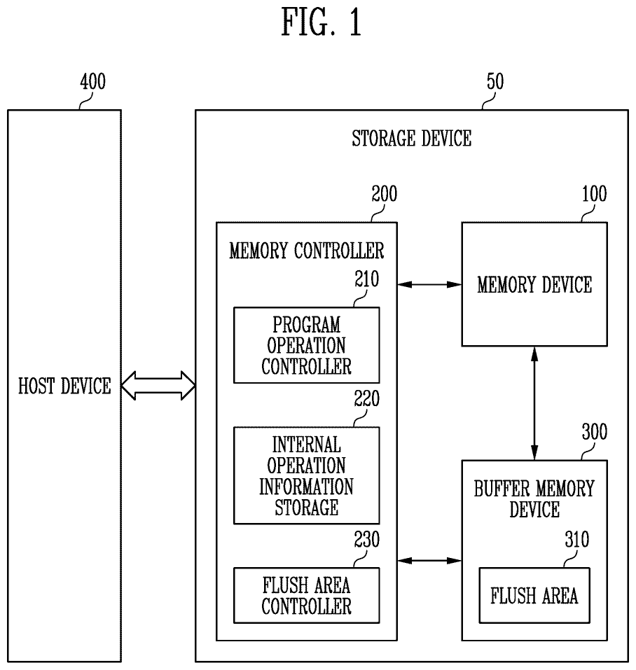

FIG. 1 is a diagram illustrating a storage device 50 according to an embodiment of the present disclosure.

Referring to FIG. 1, the storage device 50 may include a memory device 100, a buffer memory device 300, and a memory controller 200 which controls the operation of the memory device 100 and the buffer memory device 300. The storage device 50 may be a device which stores data under the control of a host device (i.e., an external device) 400, such as a mobile phone, a smartphone, an MP3 player, a laptop computer, a desktop computer, a game console, a television (TV), a tablet PC, or an in-vehicle infotainment system.

The storage device 50 may be implemented as any of various types of storage devices, for example, a solid state disk (SSD), a multimedia card such as an MMC, an embedded MMC (eMMC), a reduced size MMC (RS-MMC), or a micro-MMC, a secure digital card such as an SD, a mini-SD, or a micro-SD, a universal serial bus (USB) storage device, a universal flash storage (UFS) device, a personal computer memory card international association (PCMCIA) card-type storage device, a peripheral component interconnection (PCI)-card type storage device, a PCI express (PCI-E) card-type storage device, a compact flash (CF) card, a smart media card, and a memory stick depending on a method for communication with the host device 400.

The storage device 50 may be manufactured in any of various types of package forms. For example, the storage device 50 may be manufactured in any of various types of package forms, such as package on package (POP), system in package (SIP), system on chip (SOC), multi-chip package (MCP), chip on board (COB), wafer-level fabricated package (WFP), and wafer-level stack package (WSP).

The memory device 100 may store data. The memory device 100 may be operated in response to the control of the memory controller 200. The memory device 100 may include a plurality of memory blocks which store data. Each memory block may include a plurality of memory cells.

In an embodiment, the memory device 100 may be a nonvolatile memory in which data is retained even when power is interrupted. In the present specification, for convenience of description, description will be made based on that the memory device 100 is a NAND flash memory.

In an embodiment, the memory device 100 may receive a command and an address from the memory controller 200. The memory device 100 may perform an operation indicated by the command on an area selected by the address. For example, the memory device 100 may perform a write operation (or a program operation), a read operation, and an erase operation.

The buffer memory device 300 may temporarily store data that is provided from the host device 400 or data that is read and output from the memory device 100. For example, the buffer memory device 300 may be a volatile memory device. Therefore, when power is interrupted, the data stored in the buffer memory device 300 may not be retained.

In an embodiment, the buffer memory device 300 may control a flush area 310 therein. The flush area 310 may temporarily store the data provided from the host device 400. For example, the data stored in the flush area 310 may be provided to the memory device 100 in response to a request from the host device 400. Further, when a specific condition such as a condition in which the usage of the flush area 310 reaches a preset value is satisfied, the data stored in the flush area 310 may be provided to the memory device 100.

Although the buffer memory device 300 is illustrated in FIG. 1 as being included in the storage device 50 and being located outside the memory controller 200, the buffer memory device 300 may be located inside the memory controller 200 in various embodiments.

The memory controller 200 may control the overall operation of the storage device 50.

When power is applied to the storage device 50, the memory controller 200 may run the firmware (FW). When the memory device 100 is a flash memory device, the firmware (FW) may include a host interface layer (HIL) which controls communication with the host device 400, a flash translation layer (FTL) which controls communication between the host device 400 and the memory device 100, and a flash interface layer (FIL) which controls communication with the memory device 100.

In an embodiment, the memory controller 200 may receive data and a logical block address (LBA) from the host device 400, and may translate the logical block address (LBA) into a physical block address (PBA) indicating the address of memory cells which are included in the memory device 100 and in which the data is to be stored. In the present specification, a logical block address and a “logical address” may be used interchangeably with each other. In the present specification, a physical block address and a “physical address” may be used interchangeably with each other.

In an embodiment, the memory controller 200 may provide a command, an address, or data corresponding to a program operation, a read operation or an erase operation to the memory device 100 so that the corresponding operation is performed in response to a request from the host device 400.

In an embodiment, the memory controller 200 may independently generate a command, an address, and data regardless of whether the request of the host device 400 is received, and may transmit them to the memory device 100. For example, the memory controller 200 may provide the memory device 100 with commands, addresses, and data which are required for performing program operations and read operations associated with performance of internal operations such as a wear leveling operation, a read reclaim operation, and a garbage collection operation.

In an embodiment, the memory controller 200 may include a program operation controller 210, an internal operation information storage 220, and a flush area controller 230.

The program operation controller 210 may control a program operation. For example, the program operation controller 210 may receive data to be programmed and an address, together with a program request, from the host device 400. The program operation controller 210 may control the flush area 310 to temporarily store the data provided from the host device 400.

Further, the program operation controller 210 may control a flush operation of shifting the data stored in the flush area 310 to the memory device 100 in response to a request from the host device 400 or depending on a specific condition. For example, the program operation controller 210 may control the flush area 310 and the memory device 100 so that the data stored in the flush area 310 is provided to and stored in the memory device 100 in response to the request from the host device 400. Furthermore, when the specific condition such as a condition in which the usage of the flush area 310 reaches a preset value is satisfied, the program operation controller 210 may control the flush area 310 and the memory device 100 so that the data stored in the flush area 310 is provided to and stored in the memory device 100.

The internal operation information storage 220 may store state information related to internal operations.

In an embodiment, the state information related to the internal operations may be information related to the operation of the storage device 50, and may include information obtained by counting the number of internal operations that are performed. For example, the internal operation information storage 220 may include a counter which counts the number of internal operations.

In an embodiment, the internal operation information storage 220 may count the number of internal operations at preset periods. For example, the internal operation information storage 220 may store the number of internal operations corresponding to each of the periods.

In an embodiment, the internal operation information storage 220 may count the number of internal operations performed during a preset time in each period. The times set in respective periods may be identical to or different from each other.

In an embodiment, the flush area controller 230 may adjust the size of the flush area 310 based on the number of internal operations.

For example, the flush area controller 230 may determine whether a trigger operation of adjusting the size of the flush area 310 based on the number of internal operations is satisfied. Also, the flush area controller 230 may adjust the size of the flush area 310 when it is determined that the trigger condition is satisfied.

In an embodiment, the flush area controller 230 may determine whether the possibility of losing the data stored in the flush area 310 has relatively increased, based on the number of internal operations corresponding to each of the plurality of periods.

In an embodiment, the possibility of data loss may refer to the probability that the data stored in the flush area 310 will be lost. For example, as the possibility of data loss is higher, the probability that the data will be lost may be higher, whereas as the possibility of data loss is lower, the probability that the data will be lost may be lower.

In an embodiment, when the number of internal operations counted during a first period among the plurality of periods is greater than the number of internal operations counted during a second period previous to the first period, the flush area controller 230 may determine that the possibility of loss corresponding to the first period is higher than the possibility of loss corresponding to the second period. Here, the possibility of loss corresponding to the first period may refer to the probability that the data stored in the flush area 310 will be lost during the first period. Also, the possibility of loss corresponding to the second period may refer to the probability that the data stored in the flush area 310 will be lost during the second period. Further, when the number of internal operations counted during the first period is less than the number of internal operations counted during the second period, the flush area controller 230 may determine that the possibility of loss corresponding to the first period is lower than the possibility of loss corresponding to the second period.

In an embodiment, when it is determined that the possibility of loss corresponding to the first period is higher than the possibility of loss corresponding to the second period, the flush area controller 230 may decrease the size of the flush area 310. In an embodiment, when it is determined that the possibility of loss corresponding to the first period is lower than the possibility of loss corresponding to the second period, the flush area controller 230 may increase the size of the flush area 310 or restore the size to the original size thereof.

The host device 400 may communicate with the storage device 50 using at least one of various communication standards or interfaces such as universal serial bus (USB), serial AT attachment (SATA), serial Attached SCSI (SAS), high speed interchip (HSIC), small computer system interface (SCSI), peripheral component interconnection (PCI), PCI express (PCIe), nonvolatile memory express (NVMe), universal flash storage (UFS), secure digital (SD), multimedia card (MMC), embedded MMC (eMMC), dual in-line memory module (DIMM), registered DIMM (RDIMM), and load reduced DIMM (LRDIMM) communication methods.

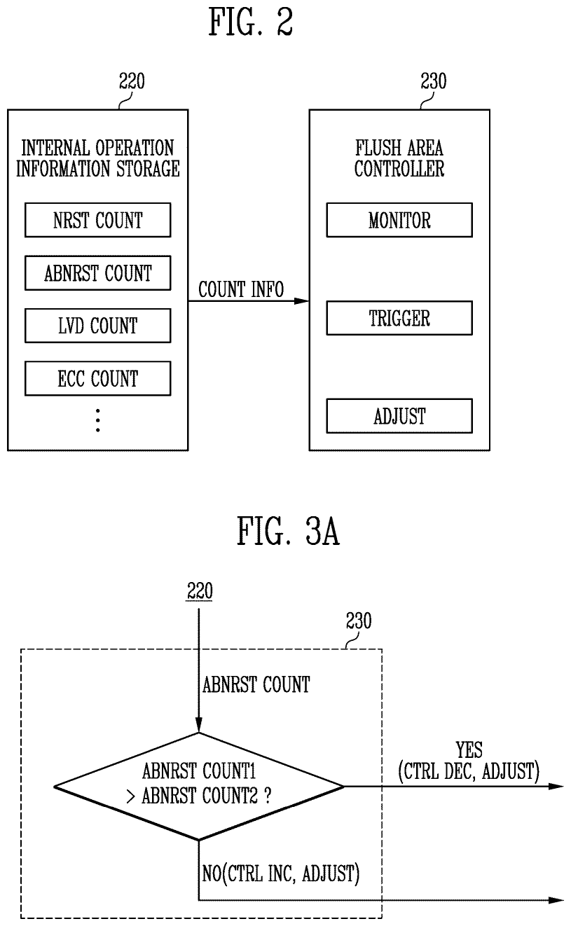

FIG. 2 is a diagram illustrating internal operation information related to the possibility of losing data stored in a flush area and an operation of adjusting the size of the flush area, according to an embodiment of the present disclosure.

Referring to FIG. 2, the internal operation information storage 220 may count and store the number of internal operations at preset periods.

In an embodiment, the internal operations may be operations related to the possibility of losing data stored in the flush area 310.

In an embodiment, the internal operations may include an operation of determining whether a supply voltage (power voltage) supplied to the storage device 50 is stable, or determining the degree of degradation of the flush area 310. In detail, the more unstable the supply voltage supplied to the storage device 50, the higher the possibility of losing the data stored in the flush area 310, and the more stable the supply voltage supplied to the storage device 50, the lower the possibility of losing the data stored in the flush area 310. Further, the higher the degree of degradation of the flush area 310, the higher the possibility of data loss, and the lower the degree of degradation of the flush area 310, the lower the possibility of data loss.

For example, the internal operations may include a normal reset operation in which the supply voltage supplied to the storage device 50 is interrupted in response to a normal control signal and is then supplied again, an abnormal reset operation in which the supply voltage is suddenly interrupted and is then supplied again, an operation of detecting a voltage abnormality in which the supply voltage decreases from a reference voltage, an error correction operation performed in the flush area 310, an error correction operation performed in the buffer memory device 300, etc.

For example, the internal operation information storage 220 may store the number of normal reset operations NRST COUNT, the number of abnormal reset operations ABNRST COUNT, the number of voltage abnormality detection operations LVD COUNT (i.e., low voltage directive: LVD COUNT), the number of error correction operations ECC COUNT, etc.

The internal operation information storage 220 may provide information about the number of internal operations COUNT INFO to the flush area controller 230.

In an embodiment, the flush area controller 230 may adjust the size of the flush area based on the information about the number of internal operations COUNT INFO.

In an embodiment, the flush area controller 230 may store data that is used to adjust the size of the flush area. Such data may be stored in the form of register values. For example, the flush area controller 230 may store monitoring data MONITOR, trigger data TRIGGER, adjustment value data ADJUST, etc.

In an embodiment, the monitoring data MONITOR may be data indicating whether the number of internal operations satisfies a specific condition. For example, the monitoring data MONITOR may be data indicating whether the possibility of losing the data stored in the flush area has relatively increased when the number of internal operations satisfies the specific condition.

The trigger data TRIGGER may be data indicating whether a condition in which the operation of adjusting the flush area is triggered is satisfied based on the number of internal operations.

The adjustment value data ADJUST may be data indicating the size, ratio, etc. to which the flush area is adjusted when the operation of adjusting the flush area is triggered.

In an embodiment, the flush area controller 230 may determine whether the trigger condition is satisfied based on the result of comparing the number of internal operations counted during a current period with the number of internal operations counted during a previous period. For example, the flush area controller 230 may determine that the trigger condition is satisfied when the number of internal operations counted during a first period is greater than the number of internal operations counted during a second period previous to the first period. In this case, the flush area controller 230 may set the monitoring data MONITOR and the trigger data TRIGGER to a first value. When the monitoring data MONITOR is set to the first value, it may indicate that the number of internal operations satisfies the specific condition, and thus the possibility of losing data stored in the flush area has relatively increased. When the trigger data TRIGGER is set to the first value, it may indicate that a trigger condition for the operation of adjusting the flush area is satisfied.

In an embodiment, the flush area controller 230 may determine whether the possibility of losing the data stored in the flush area has relatively increased based on the result of comparing the number of internal operations counted during the current period with the number of internal operations counted during the previous period. Furthermore, when it is determined that the possibility of losing the data stored in the flush area has relatively increased, the flush area controller 230 may determine whether the trigger condition is satisfied based on the result of comparing the number of internal operations counted during the current period with the number of internal operations counted during the next period. For example, the flush area controller 230 may determine whether the trigger condition is satisfied based on the number of internal operations counted during a third period subsequent to the first period when the number of internal operations counted during the first period is greater than the number of internal operations counted during the second period. In this case, the flush area controller 230 may set the monitoring data MONITOR to the first value. Thereafter, the flush area controller 230 may determine that the trigger condition is satisfied when the number of internal operations counted during the third period is greater than the number of internal operations counted during the first period. In this case, the flush area controller 230 may maintain the monitoring data MONITOR at the first value, and may set the trigger data TRIGGER to the first value.

In an embodiment, the flush area controller 230 may set the monitoring data MONITOR and the trigger data TRIGGER to a second value when the number of internal operations counted during the current period is equal to or less than the number of internal operations counted during the previous period. When the monitoring data MONITOR is set to the second value, it may indicate that the number of internal operations does not satisfy the specific condition, and thus the possibility of losing the data stored in the flush area is relatively low. When the trigger data TRIGGER is set to the second value, it may indicate that the trigger condition for the operation of adjusting the flush area is not satisfied.

In an embodiment, when the trigger condition is satisfied, the flush area controller 230 may decrease the size of the flush area based on the adjustment value data ADJUST.

In an embodiment, when the trigger condition is not satisfied, the flush area controller 230 may increase the size of the flush area or restore the size to a default size based on the adjustment value data ADJUST.

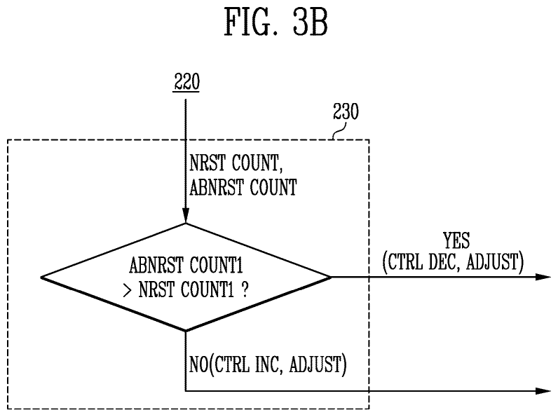

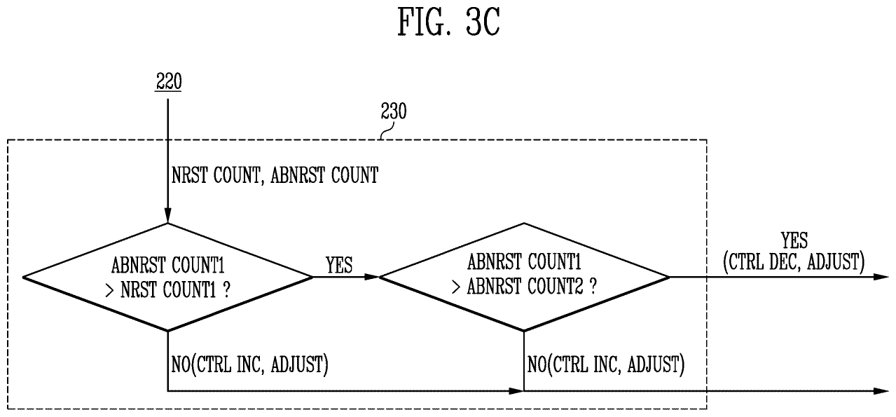

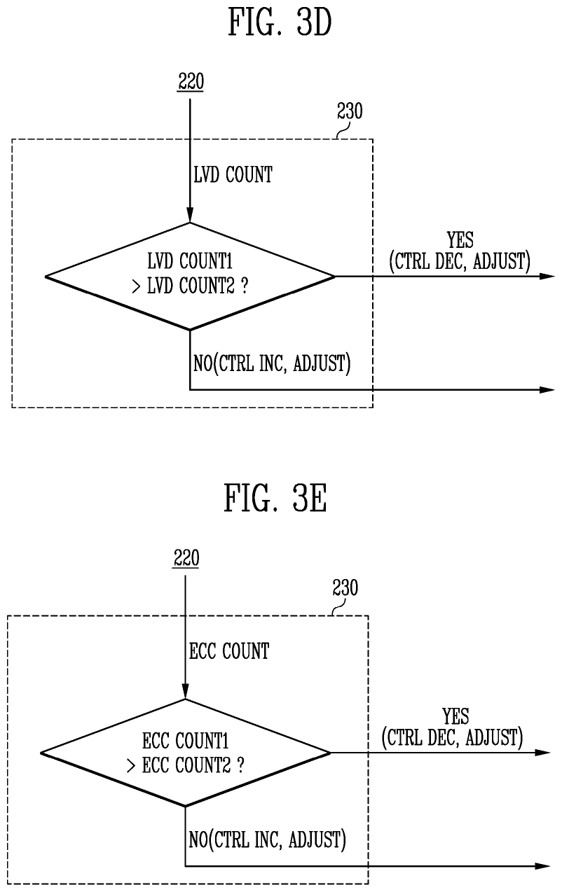

FIGS. 3A to 3E are diagrams illustrating an operation of determining whether a trigger condition is satisfied according to an embodiment of the present disclosure. In FIGS. 3A to 3E, for convenience of description, an operation of determining whether a trigger condition is satisfied so as to set trigger data TRIGGER will be described. The embodiments illustrated in FIGS. 3A to 3E may also be equally applied to an embodiment of determining whether the possibility of losing data stored in a flush area is relatively high so as to set monitoring data MONITOR before determining whether the trigger condition is satisfied.

FIG. 3A is a diagram illustrating an operation of determining whether a trigger condition is satisfied based on the number of abnormal reset operations ABNRST COUNT.

Referring to FIG. 3A, the flush area controller 230 may receive the number of abnormal reset operations ABNRST COUNT from the internal operation information storage 220.

In an embodiment, when the number of abnormal reset operations ABNRST COUNT1 counted during a first period is greater than the number of abnormal reset operations ABNRST COUNT2 counted during a second period previous to the first period, the flush area controller 230 may output a control signal CTRL DEC and adjustment value data ADJUST for decreasing the size of the flush area.

In an embodiment, when the number of abnormal reset operations ABNRST COUNT1 counted during the first period is equal to or less than the number of abnormal reset operations ABNRST COUNT2 counted during the second period, the flush area controller 230 may output a control signal CTRL INC and adjustment value data ADJUST for increasing the size of the flush area.

FIG. 3B is a diagram illustrating an operation of determining whether the trigger condition is satisfied based on the result of comparing the number of normal reset operations NRST COUNT with the number of abnormal reset operations ABNRST COUNT.

Referring to FIG. 3B, the flush area controller 230 may receive the number of normal reset operations NRST COUNT and the number of abnormal reset operations ABNRST COUNT from the internal operation information storage 220.

In an embodiment, when the number of abnormal reset operations ABNRST COUNT1 counted during the first period is greater than the number of normal reset operations NRST COUNT1 counted during the first period, the flush area controller 230 may output a control signal CTRL DEC and adjustment value data ADJUST for decreasing the size of the flush area.

In an embodiment, when the number of abnormal reset operations ABNRST COUNT1 counted during the first period is equal to or less than the number of normal reset operations NRST COUNT1 counted during the first period, the flush area controller 230 may output a control signal CTRL INC and adjustment value data ADJUST for increasing the size of the flush area.

FIG. 3C is a diagram illustrating an operation of determining whether the trigger condition is satisfied based on the result of comparing the number of normal reset operations NRST COUNT with the number of abnormal reset operations ABNRST COUNT.

Referring to FIG. 3C, the flush area controller 230 may receive the number of normal reset operations NRST COUNT and the number of abnormal reset operations ABNRST COUNT from the internal operation information storage 220.

In an embodiment, when the number of abnormal reset operations ABNRST COUNT1 counted during the first period is greater than the number of normal reset operations NRST COUNT1 counted during the first period, the flush area controller 230 may compare the number of abnormal reset operations ABNRST COUNT1 counted during the first period with the number of abnormal reset operations ABNRST COUNT2 counted during the second period.

In an embodiment, when the number of abnormal reset operations ABNRST COUNT1 counted during the first period is greater than the number of abnormal reset operations ABNRST COUNT2 counted during the second period, the flush area controller 230 may output a control signal CTRL DEC and adjustment value data ADJUST for decreasing the size of the flush area.

In an embodiment, when the number of abnormal reset operations ABNRST COUNT1 counted during the first period is equal to or less than the number of normal reset operations NRST COUNT1 counted during the first period, the flush area controller 230 may output a control signal CTRL INC and adjustment value data ADJUST for increasing the size of the flush area.

In an embodiment, when the number of abnormal reset operations ABNRST COUNT1 counted during the first period is equal to or less than the number of abnormal reset operations ABNRST COUNT2 counted during the second period, the flush area controller 230 may output a control signal CTRL INC and adjustment value data ADJUST for increasing the size of the flush area.

FIG. 3D is a diagram illustrating an operation of determining whether the trigger condition is satisfied based on the number of operations of detecting a voltage abnormality LVD COUNT.

Referring to FIG. 3D, the flush area controller 230 may receive the number of voltage abnormality detection operations LVD COUNT from the internal operation information storage 220.

In an embodiment, when the number of voltage abnormality detection operations LVD COUNT1 counted during the first period is greater than the number of voltage abnormality detection operations LVD COUNT2 counted during the second period, the flush area controller 230 may output a control signal CTRL DEC and adjustment value data ADJUST for decreasing the size of the flush area.

In an embodiment, when the number of voltage abnormality detection operations LVD COUNT1 counted during the first period is equal to or less than the number of voltage abnormality detection operations LVD COUNT2 counted during the second period, the flush area controller 230 may output a control signal CTRL INC and adjustment value data ADJUST for increasing the size of the flush area.

FIG. 3E is a diagram illustrating an operation of determining whether the trigger condition is satisfied based on the number of error correction operations ECC COUNT performed in the flush area 310. Although, in FIG. 3E, whether the trigger condition is satisfied is determined based on the number of error correction operations ECC COUNT performed in the flush area 310, whether the trigger condition is satisfied may be determined based on the number of error correction operations performed in the buffer memory device 300 according to an embodiment.

Referring to FIG. 3E, the flush area controller 230 may receive the number of error correction operations ECC COUNT from the internal operation information storage 220.

In an embodiment, when the number of error correction operations ECC COUNT1 counted during the first period is greater than the number of error correction operations ECC COUNT2 counted during the second period, the flush area controller 230 may output a control signal CTRL DEC and adjustment value data ADJUST for decreasing the size of the flush area.

In an embodiment, when the number of error correction operations ECC COUNT1 counted during the first period is equal to or less than the number of error correction operations ECC COUNT2 counted during the second period, the flush area controller 230 may output a control signal CTRL INC and adjustment value data ADJUST for increasing the size of the flush area.

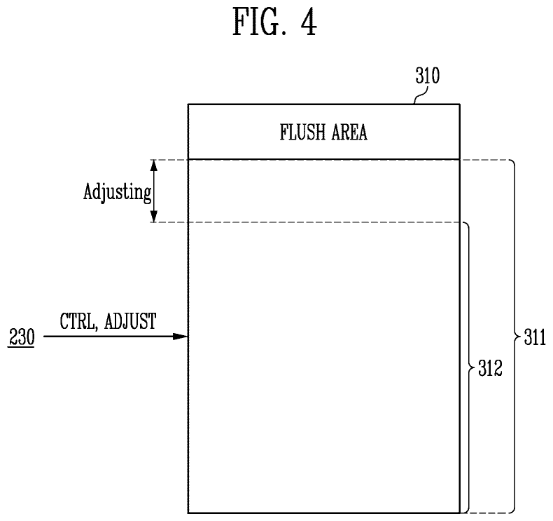

FIG. 4 is a diagram illustrating an operation of adjusting the size of a flush area, according to an embodiment of the present disclosure.

Referring to FIG. 4, the flush area 310 may have a default size 311 as an initially set size.

The size of the flush area 310 may be adjusted based on a control signal CTRL and adjustment value data ADJUST that are output from the flush area controller 230.

In an embodiment, when it is determined that the trigger condition is satisfied, the flush area controller 230 may decrease the size of the flush area 310 from the default size 311 by a preset value. The preset value may refer to the adjustment value data ADJUST. Accordingly, the flush area 310 may have a decreased size 312.

In an embodiment, when it is determined that the trigger condition is satisfied again after the size of the flush area 310 has decreased, the flush area controller 230 may further decrease the decreased size of the flush area 310 by the preset value.

Accordingly, the program operation controller 210 may perform a flush operation based on the decreased size 312 of the flush area. For example, the program operation controller 210 may provide information about the decreased size 312 of the flush area to the host device 400. The host device 400 may transmit a flush request to the storage device 50 in consideration of the decreased size 312 of the flush area, and the program operation controller 210 may perform a flush operation. In an example, the program operation controller 210 may perform the flush operation when usage based on the decreased size 312 of the flush area reaches a preset value.

In an embodiment, when it is determined that the trigger condition is not satisfied after the size of the flush area 310 has decreased, the flush area controller 230 may restore the decreased size 312 of the flush area 310 to the default size 311.

In an embodiment, when it is determined that the trigger condition is not satisfied after the size of the flush area 310 has decreased, the flush area controller 230 may increase the decreased size 312 of the flush area by the preset value.

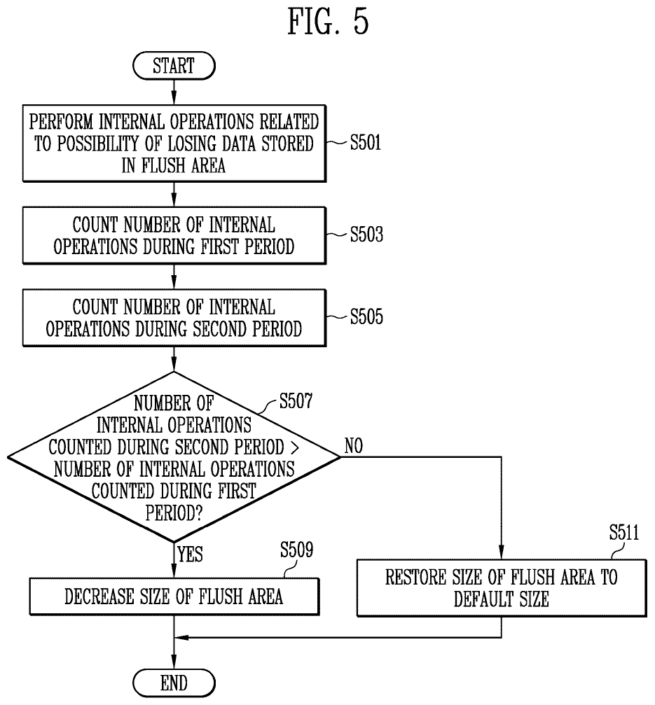

FIG. 5 is a flowchart illustrating a method of operating a storage device according to an embodiment of the present disclosure.

The method illustrated in FIG. 5 may be performed by, for example, the storage device 50 illustrated in FIG. 1.

Referring to FIG. 5, at operation S501, the storage device 50 may perform internal operations related to the possibility of losing data stored in a flush area.

At operation S503, the storage device 50 may count the number of internal operations during a first period.

At operation S505, the storage device 50 may count the number of internal operations during a second period subsequent to the first period.

At operation S507, the storage device 50 may compare the number of internal operations counted during the first period with the number of internal operations counted during the second period. That is, the storage device 50 may determine whether the number of internal operations counted during the second period is greater than the number of internal operations counted during the first period.

When the number of internal operations counted during the second period is greater than the number of internal operations counted during the first period (“YES” at the operation S507), the storage device 50 may perform operation S509.

For example, when the number of abnormal reset operations counted during the second period is greater than the number of abnormal reset operations counted during the first period, the storage device 50 may perform the operation S509.

For example, when the number of abnormal reset operations counted during the second period is greater than the number of normal reset operations counted during the second period, the storage device 50 may perform the operation S509.

For example, when the number of abnormal reset operations counted during the second period is greater than the number of normal reset operations counted during the second period and the number of abnormal reset operations counted during the second period is greater than the number of abnormal reset operations counted during the first period, the storage device 50 may perform the operation S509.

For example, when the number of voltage abnormality detection operations counted during the second period is greater than the number of voltage abnormality detection operations counted during the first period, the storage device 50 may perform the operation S509.

For example, when the number of error correction operations counted during the second period is greater than the number of error correction operations counted during the first period, the storage device 50 may perform the operation S509.

At the operation S509, the storage device 50 may decrease the size of the flush area by a preset value. Further, the storage device 50 may set monitoring data and trigger data to a first value.

On the other hand, when the number of internal operations counted during the second period is equal to or less than the number of internal operations counted during the first period (“NO” at the operation S507), the storage device 50 may perform operation S511.

At the operation S511, the storage device 50 may restore the size of the flush area to a default size.

Further, the storage device 50 may set the monitoring data and trigger data to a second value.

Furthermore, when the size of the flush area has decreased, the storage device 50 may increase the size of the flush area by a preset value.

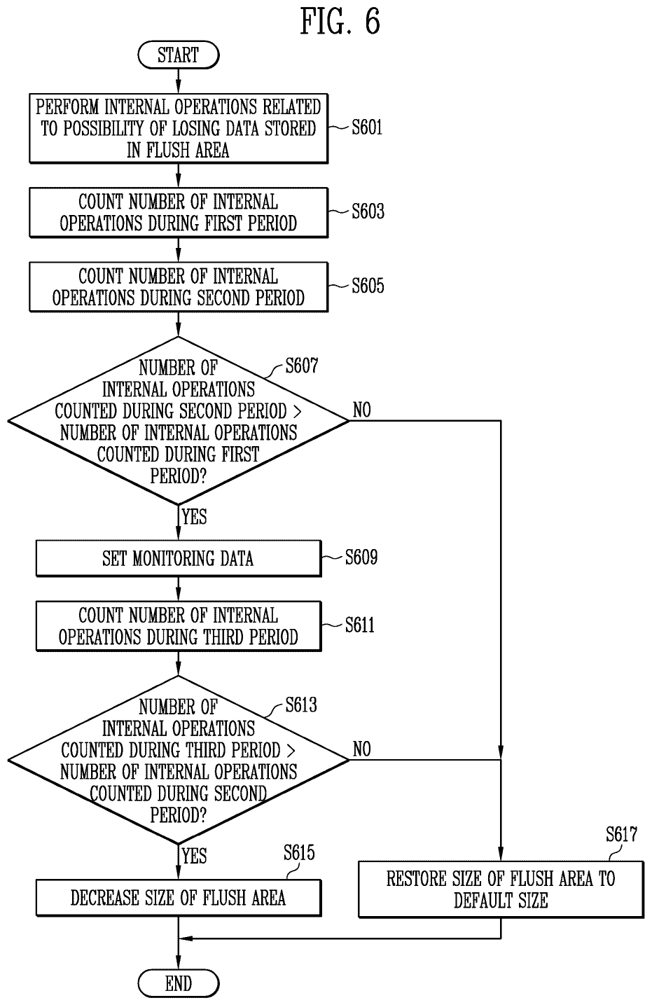

FIG. 6 is a flowchart illustrating a method of operating a storage device according to an embodiment of the present disclosure.

The method illustrated in FIG. 6 may be performed by, for example, the storage device 50 illustrated in FIG. 1.

Referring to FIG. 6, at operation S601, the storage device 50 may perform internal operations related to the possibility of losing data stored in a flush area.

At operation S603, the storage device 50 may count the number of internal operations during a first period.

At operation S605, the storage device 50 may count the number of internal operations during a second period subsequent to the first period.

At operation S607, the storage device 50 may compare the number of internal operations counted during the first period with the number of internal operations counted during the second period. That is, the storage device 50 may determine whether the number of internal operations counted during the second period is greater than the number of internal operations counted during the first period.

When the number of internal operations counted during the second period is greater than the number of internal operations counted during the first period (“YES” at the operation S607), the storage device 50 may perform operation S609.

For example, when the number of abnormal reset operations counted during the second period is greater than the number of abnormal reset operations counted during the first period, the storage device 50 may perform the operation S609.

For example, when the number of abnormal reset operations counted during the second period is greater than the number of normal reset operations counted during the second period, the storage device 50 may perform the operation S609.

For example, when the number of abnormal reset operations counted during the second period is greater than the number of normal reset operations counted during the second period and the number of abnormal reset operations counted during the second period is greater than the number of abnormal reset operations counted during the first period, the storage device 50 may perform the operation S609.

For example, when the number of voltage abnormality detection operations counted during the second period is greater than the number of voltage abnormality detection operations counted during the first period, the storage device 50 may perform the operation S609.

For example, when the number of error correction operations counted during the second period is greater than the number of error correction operations counted during the first period, the storage device 50 may perform the operation S609.

At the operation S609, the storage device 50 may set monitoring data. For example, the storage device 50 may set the monitoring data to a first value.

At operation S611, the storage device 50 may count the number of internal operations during a third period.

At operation S613, the storage device 50 may compare the number of internal operations counted during the second period with the number of internal operations counted during the third period. That is, the storage device 50 may determine whether the number of internal operations counted during the third period is greater than the number of internal operations counted during the second period.

When the number of internal operations counted during the third period is greater than the number of internal operations counted during the second period (“YES” at the operation S613), the storage device 50 may perform operation S615.

For example, when the number of abnormal reset operations counted during the third period is greater than the number of abnormal reset operations counted during the second period, the storage device 50 may perform the operation S615.

For example, when the number of abnormal reset operations counted during the third period is greater than the number of normal reset operations counted during the third period, the storage device 50 may perform the operation S615.

For example, when the number of abnormal reset operations counted during the third period is greater than the number of normal reset operations counted during the third period and the number of abnormal reset operations counted during the third period is greater than the number of abnormal reset operations counted during the second period, the storage device 50 may perform the operation S615.

For example, when the number of voltage abnormality detection operations counted during the third period is greater than the number of voltage abnormality detection operations counted during the second period, the storage device 50 may perform the operation S615.

For example, when the number of error correction operations counted during the third period is greater than the number of error correction operations counted during the second period, the storage device 50 may perform the operation S615.

At the operation S615, the storage device 50 may decrease the size of the flush area according to a preset value.

On the other hand, when the number of internal operations counted during the second period is equal to or less than the number of internal operations counted during the first period (“NO” at the operation S607), or when the number of internal operations counted during the third period is equal to or less than the number of internal operations counted during the second period (“NO” at the operation S613), the storage device 50 may perform operation S617.

At the operation S617, the storage device 50 may restore the size of the flush area to a default size.

Further, the storage device 50 may set the monitoring data and trigger data to a second value.

Furthermore, when the size of the flush area has decreased, the storage device 50 may increase the size of the flush area by a preset value.

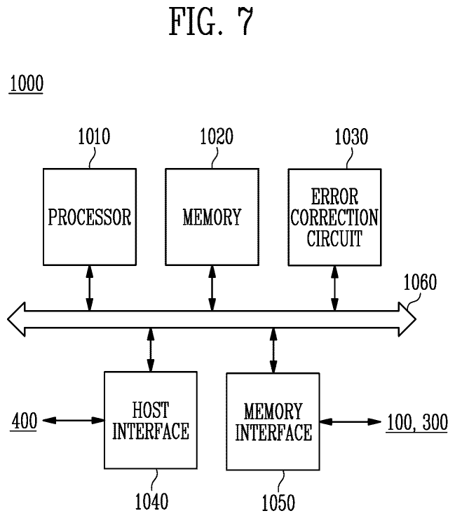

FIG. 7 is a diagram illustrating a memory controller according to an embodiment of the present disclosure. A memory controller 1000 illustrated in FIG. 7 may refer to the memory controller 200 illustrated in FIG. 1.

Referring to FIG. 7, the memory controller 1000 may include a processor 1010, a memory 1020, an error correction circuit 1030, a host interface 1040, a memory interface 1050, and a communication bus 1060. In the memory controller 1000, the processor 1010, the memory 1020, the error correction circuit 1030, the host interface 1040, and the memory interface 1050 may communicate with each other through the communication bus 1060.

The processor 1010 may execute firmware, code or one or more instructions, which include various types of information required for the operation of the memory controller 1000. In an embodiment, the program operation controller 210 and the flush area controller 230 of FIG. 1 may be implemented using one or more components stored in the processor 1010.

The memory 1020 may serve as a buffer memory, a cache memory, a working memory, or the like. In an embodiment, the internal operation information storage 220 of FIG. 1 may be implemented using one or more components included in the memory 1020.

Further, the memory 1020 may store the firmware, code or one or more instructions including various types of information required for the operation of the memory controller 1000.

The error correction circuit 1030 may perform an error correction operation when data is stored in the memory device 100 or the buffer memory device 300, or when data is read from the memory device 100 or buffer memory device 300. For example, the error correction circuit 1030 may perform error correcting code (ECC) encoding based on data to be written to the memory device 100 or the buffer memory device 300. The encoded data may be transferred to the memory device 100 or the buffer memory device 300. The error correction circuit 1030 may perform error correcting code (ECC) decoding on data received from the memory device 100 or the buffer memory device 300.

The memory controller 1000 may communicate with an external device (e.g., the host device 400, an application processor or the like) through the host interface 1040.

The memory controller 1000 may communicate with the memory device 100 or the buffer memory device 300 through the memory interface 1050. The memory controller 1000 may transmit a command, an address, a control signal, or the like to the memory device 100 or the buffer memory device 300 and receive data from the memory device 100 or the buffer memory device 300, through the memory interface 1050.

According to the embodiments of the present disclosure, there are provided a storage device and a method of operating the storage device, which can minimize data loss by variably controlling the size of a flush area, thus improving reliability.

Various embodiments of the present disclosure have been disclosed herein, and although specific terms are employed, they are used and are to be interpreted in a generic and descriptive sense only and not for the purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present disclosure as set forth in the following claims. Furthermore, the embodiments may be combined to form additional embodiments.

What is claimed is:

1. A storage device comprising:
a buffer memory device including a flush area configured to temporarily store data provided from a host;
a memory device configured to store the data output from the flush area in response to a request from the host; and
a memory controller configured to adjust a size of the flush area based on a number of internal operations related to a possibility of losing the data stored in the flush area.

2. The storage device according to claim 1, wherein the memory controller is configured to:
count the number of the internal operations at preset periods; and
determine whether a trigger condition for an operation of adjusting the size of the flush area is satisfied based on the number of the internal operations.

3. The storage device according to claim 2, wherein the memory controller is configured to determine that the trigger condition is satisfied when a number of the internal operations counted during a second period is greater than a number of the internal operations counted during a first period previous to the second period.

4. The storage device according to claim 3, wherein the memory controller is configured to, when the number of the internal operations counted during the second period is greater than the number of the internal operations counted during the first period, determine whether the trigger condition is satisfied based on a number of the internal operations counted during a third period subsequent to the second period.

5. The storage device according to claim 4, wherein the memory controller is configured to determine that the trigger condition is satisfied when the number of the internal operations counted during the third period is greater than the number of the internal operations counted during the second period.

6. The storage device according to claim 1, wherein the internal operations include an operation of determining whether a supply voltage supplied to the storage device is stable.

7. The storage device according to claim 6, wherein the internal operations include at least one of a normal reset operation in which the supply voltage is interrupted in response to a control signal and is then supplied again, an abnormal reset operation in which the supply voltage is suddenly interrupted and is then supplied again, and an operation of detecting a voltage abnormality in which the supply voltage decreases from a reference voltage.

8. The storage device according to claim 1, wherein the internal operations include an operation of determining a degree of degradation of the flush area.

9. The storage device according to claim 8, wherein the internal operations include an error correction operation performed in the flush area.

10. The storage device according to claim 2, wherein the memory controller is configured to adjust the size of the flush area to have a decreased size less than a default size by a preset value when the trigger condition is satisfied.

11. The storage device according to claim 10, wherein the memory controller is configured to adjust the size of the flush area having the decreased size to have a further decreased size less than the decreased size by the preset value when the trigger condition is satisfied again after the size of the flush area has decreased.

12. The storage device according to claim 10, wherein the memory controller is configured to restore the decreased size of the flush area to the default size when the trigger condition is not satisfied after the size of the flush area has decreased.

13. The storage device according to claim 10, wherein the memory controller is configured to adjust the size of the flush area to have an increased size greater than the decreased size by the preset value when the trigger condition is not satisfied after the size of the flush area has decreased.

14. A method of operating a storage device, the storage device including a flush area configured to temporarily store data provided from a host, the method comprising:
performing internal operations related to a possibility of losing data stored in the flush area;
counting a number of the internal operations during a first period;
counting a number of the internal operations during a second period subsequent to the first period;
comparing the number of the internal operations counted during the first period with the number of the internal operations counted during the second period; and
adjusting a size of the flush area based on a result of comparing the number of the internal operations counted during the first period with the number of the internal operations counted during the second period.

15. The method according to claim 14, wherein the internal operations include an operation of determining whether a supply voltage supplied to the storage device is stable or determining a degree of degradation of the flush area.

16. The method according to claim 15, wherein the adjusting of the size of the flush area comprises:
decreasing the size of the flush area by a preset value in response to a case where a number of abnormal reset operations counted during the second period is greater than a number of abnormal reset operations counted during the first period.

17. The method according to claim 15, wherein the adjusting of the size of the flush area comprises:
decreasing the size of the flush area by a preset value in response to a case where a number of abnormal reset operations counted during the second period is greater than a number of normal reset operations counted during the second period.

18. The method according to claim 15, wherein the adjusting of the size of the flush area comprises:
decreasing the size of the flush area by a preset value in response to a case where a number of abnormal reset operations counted during the second period is greater than a number of normal reset operations counted during the second period and where the number of abnormal reset operations counted during the second period is greater than the number of abnormal reset operations counted during the first period.

19. The method according to claim 15, wherein the adjusting of the size of the flush area comprises:
decreasing the size of the flush area by a preset value in response to a case where a number of voltage abnormality detection operations counted during the second period is greater than a number of voltage abnormality detection operations counted during the first period.

20. The method according to claim 15, wherein the adjusting of the size of the flush area comprises:
decreasing the size of the flush area by a preset value in response to a case where a number of error correction operations counted during the second period is greater than the number of error correction operations counted during the first period.

21. A memory controller for controlling a flush area configured to temporarily store data provided from a host, the memory controller comprising:
an internal operation information storage configured to store a number of internal operations related to a possibility of losing data stored in the flush area for each of a plurality of periods; and
a flush area controller configured to adjust a size of the flush area based on the number of internal operations corresponding to each of the plurality of periods.

22. The memory controller according to claim 21, wherein the flush area controller is configured to decrease the size of the flush area by a preset value when a number of internal operations counted during a second period among the plurality of periods is greater than a number of internal operations counted during a first period previous to the second period.

23. The memory controller according to claim 21, wherein the internal operations include an operation of determining whether a supply voltage supplied to the memory controller is stable or determining a degree of degradation of the flush area.
